(19) United States
(12) Patent Application Publication
(10) Pub. No.: US 2021/0390602 A1
(43) Pub. Date: Dec. 16, 2021

(54) Free Time Monetization Exchange

(71) Applicants: Jeremy R. Deutsch, New York, NY (US); Buland Madan, New York, NY (US)

(72) Inventors: Jeremy R. Deutsch, New York, NY (US); Buland Madan, New York, NY (US)

(21) Appl. No.: 17/215,970

(22) Filed: Mar. 29, 2021

Related U.S. Application Data
(63) Continuation of application No. 16/998,512, filed on Aug. 20, 2020, now abandoned.
Application No. 16/998,512 is a continuation of application No. 15/133,634, filed on Apr. 20, 2016, now abandoned.
Application No. 15/133,634 is a continuation-in-part of application No. 14/841,352, filed on Aug. 31, 2015, now abandoned.
(60) Provisional application No. 62/166,485, filed on May 26, 2015.

(51) Int. Cl. G06Q 30/06; G06Q 10/10; G06F 16/2457; G06Q 30/02; H04L 9/32

(52) U.S. Cl. CPC G06Q 30/0617; G06Q 10/1095; G06F 16/24575; H04L 63/102; G06Q 30/0217; H04L 9/3239; G06Q 30/0282; G06Q 30/0201

(57) ABSTRACT

A method for providing a time exchange for establishing a sales pitch meeting between a salesperson and a consumer or group of consumers is described. A matching engine is utilized to best match a salesperson with a consumer that is considered to be available and willing to attend the sales pitch meeting. Salespersons bid on consumers' time on an exchange. Via an Algorithm Marketplace, consumers may trade their time on one or more exchanges. The giver of the sales pitch meeting can offer incentives to encourage consumers to attend the sales pitch meeting.

### PRIORITY

This application is a continuation application of U.S. Non-Provisional application Ser. No. 16/998,512, filed Aug. 20, 2020, which is continuation application of U.S. Non-Provisional application Ser. No. 15/133,634, filed Apr. 20, 2016, which is a continuation-in-part of U.S. Non-Provisional application Ser. No. 14/841,352, filed Aug. 31, 2015, which is hereby incorporated by reference in its entirety, which claims priority to U.S. Provisional Application No. 62/166,485, filed May 26, 2015, which is hereby incorporated by reference in its entirety.

### FIELD OF THE INVENTION

The present invention relates to free time monetization, and, more particularly, a method and system for establishing a sales pitch meeting between a seller and a consumer at a convenient time via a time exchange.

### BACKGROUND OF THE INVENTION

Too often, sales pitches of any variety are given at inopportune times. This reduces the success rate of the salesperson. Additionally, unsolicited sales pitches can be viewed as a nuisance, unwanted, or inconvenient by the consumer. Or simply, a consumer just does not have the time for a sales call.

What is needed is a system that seeks to successfully match salesmen with interested potential buyers based on availability and other key factors.

### SUMMARY OF THE INVENTION

A method for establishing a meeting between a giver and a receiver, comprising receiving first information from said giver, receiving second information from said receiver, and matching said giver and said receiver based on said first information and said second information.

A method for establishing a meeting between a consumer and a seller, comprising an exchange and algorithm marketplace, where the exchange and algorithm marketplace are utilized to effectuate a meeting between the consumer and seller.

The method further comprises a review system for each of the consumers and the sellers on the exchange.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

FIG. 1 illustrates an aspect of an exemplary embodiment of the present invention.

FIG. 2 illustrates an aspect of an exemplary embodiment of the present invention.

FIG. 3 is an overview diagram of the present invention.

FIG. 4 is a workflow process of the present invention.

FIG. 5 is an overview diagram of another embodiment of the present invention.

FIG. 6 is another workflow process of another embodiment of the present invention.

### DETAILED DESCRIPTION

While the concepts of the present disclosure are susceptible to various modifications and alternative forms, specific embodiments thereof are shown by way of example in the drawings and are described in detail below. It should be understood that there is no intent to limit the concepts of the present disclosure to the particular forms disclosed. On the contrary, the intent is to cover all modifications, equivalents, and alternatives consistent with the present disclosure and the appended claims.

It is the goal of the present invention to provide a system where a sales pitch meeting is established between the giver of the sales pitch (i.e., a salesperson) and the one receiving the sales pitch (i.e., a consumer). Far too often it is hard to find an agreeable time for a sales pitch meeting. In the alternative, even when a salesperson does grab the attention of a consumer, the interest of the consumer may be easily lost (i.e., a telemarketer being hung up on). One solution set forth by the present invention is a method where, taking into account a myriad of factors, a meeting for a set duration is established between a salesperson and a consumer.

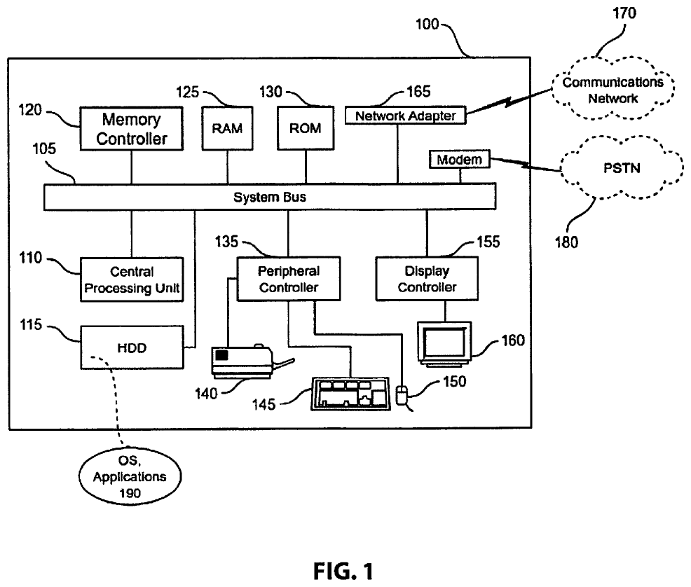

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

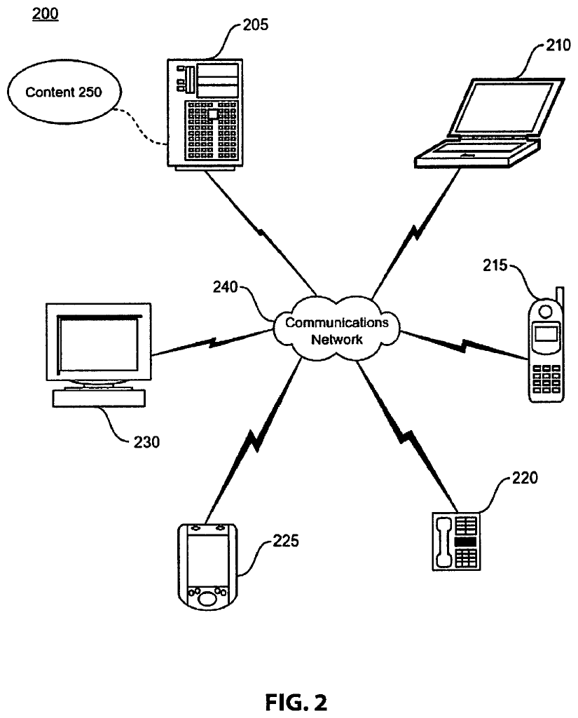

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

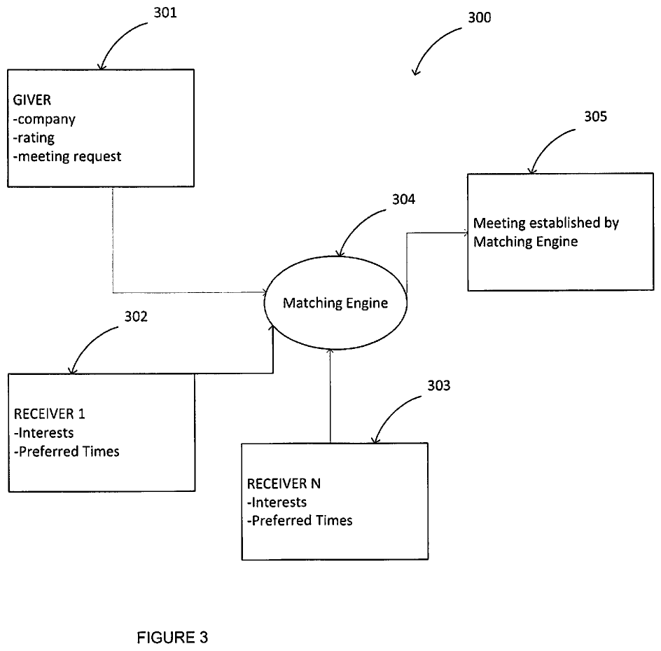

FIG. 3 is a high-level diagram 300 of how the system is intended to operate. A Giver 301, Receiver 1 302, and Receiver N 303 are all communicatively coupled to Matching Engine 304. The Matching Engine 304 receives information from the Giver 301 and the Receivers 302/303 to establish a Meeting 305. The number of participants is not considered to be limiting but instead merely to be exemplary. In at least one embodiment, the Meeting 305 can be between one Giver 301 and one Receiver 302, whereas in a second embodiment a meeting can be established between multiple givers and multiple receivers. The Matching Engine 304 can take into account information received from the givers and the receivers. A central repository (not shown) is located at the Matching Engine 304 for storing this information and establishing a profile for each. The central repository, for example a database, is either communicatively coupled to the Matching Engine 304 or externally located via an appropriate communication line over a network, as is considered known in the art and exemplified in FIG. 1. The central repository may include a hardware computing processor and memory.

A giver, or salesperson, is defined as anybody seeking to make a sales pitch to another person, or consumer. A giver's profile includes, but is not limited to, market segment, company information, product information, rating, individual analytics (age/sex), location, meeting incentives used (i.e., cab rides, cash, meals, donations, tickets, etc.), maximum meeting expenditures, and compliance rules. When a giver wishes to request a meeting, the giver can specify which meeting incentives to offer and to which category of people the giver wishes to meet with. For example, the giver can offer a pizza dinner or concert tickets to a receiver that meets a certain criteria (i.e., a college student or students) in exchange for listening to a fifteen minute sales pitch regarding a certain product (i.e., a credit card offer). A salesperson may be limited to providing certain types of incentives in accordance with specific rules. Example rules for incentives are as follows:
Only Charity incentives, or
Only incentives less than 100 USD in overall value, unless meeting at restaurant that serves alcohol, or
No incentives if restaurant serves alcohol.

Incentives may also include exemption requests. Further, incentive requests, for incentives to be offered, may be placed under an approval process. Incentive requests may be pre-approved by a monitoring entity. A monitoring entity may require a certain salesperson to have all incentives to be offered to be approved.

A receiver is defined as a consumer who makes themselves available to hear a sales pitch. A receiver's profile may include market segment, company affiliation, personal/business interests (e.g., food, restaurants, sports, music, etc.), commute time, compliance rules, availability, max spending power (personal, business), data mining statistics, biometrics, and other key criteria. Other key criteria may include demographics such as marital status, children, income, and industry. Biometrics may include heart rate, weight, blood pressure, etc. Biometrics can be monitored via a web-based application, a smart watch, specific apps on the consumer's device (i.e., smartphone, laptop, tablet), or via some other wearable device. A receiver's wearable device could report the desire of the receiver and availabilities. Further, the collected biometrics may alert a salesperson that a consumer is currently available and likely to accept a meeting. For example, a consumer's detected biometric, in this example blood glucose, is detected to be low, and the consumer is currently located in front of or near a restaurant, this scenario could generate an alert to be sent to one or more salespersons. The salespersons notified may contact this consumer with an offer to set up a meeting at the determined restaurant. The likelihood of the consumer accepting the meeting would be heightened based on the criteria tracked (biometrics and location). The system could be further set up to only notify salespersons that are actually interested in having a meeting at the detected location or restaurant. Further details regarding the consumer could be analyzed as well with respect to the consumer profile, like what they'd be interested in or what they might like to buy.

A receiver may specify their availability explicitly by manually entering their preferred meeting times via a GUI or may link their profile to their personal/business calendar like Google Calendar or Microsoft Outlook. A consumer, or receiver, is further enabled to specify key wishes, goals, or needs. In one example, a consumer can specify the type of person they'd like to meet, like an investor, that meets certain criteria (e.g., can provide 100K dollars for a market expansion of a business in exchange for equity, can meet for at least 15 minutes).

A receiver is further equipped with the ability to rate a salesperson. The rating given is then associated with the appropriate salesperson in the central repository. Based on this profile information, a further profile can be created called a “demand profile” which is then used by the matching engine. A demand profile would include user-specific information (i.e., biometrics) and specific demands so the salesperson/vendor can meet those demands. For example, a salesperson, using the matching engine, knows where the consumer is, knows they like Italian, and has a favorite restaurant. The salesperson can then set up a meeting at the Italian restaurant and buy the consumer lunch utilizing the matching engine in exchange to give the sales pitch. The system further includes a background check system of the salesperson. The consumer may prefer a certain type of salesperson to meet with and can specify this discreetly through the matching engine. For example, a consumer can specify that they will only meet salespeople of certain criteria (e.g., male/female, tall/short, blond/brunette).

In another embodiment of the invention, the rating system may be based on a weighting system where salespersons may be compared with one another. For example, salespersons may be each assigned a percentage value (e.g., 1-100). Salespersons may be assigned an initial value, for example 50, which is then adjusted over time and may be directly affected by the salesperson's performance. Salespersons with greater service time may be weighted more heavily in conjunction with their time in service, or based on their length of time using the application when compared with newer salespersons. This would prevent a veteran salesperson's overall rating from being dramatically reduced in response to a few bad ratings. Salespersons may be assigned and/or associated with a wide range of variables. The variables would include, but are not limited to, a score, a ranking, and an experience level. Ratings may also be affected by effectiveness of past sales pitches, amount of profile information provided or how specific provided profile information is with respect to quality, total number of proposals sent/received, and level activity generated based on the salesperson's profile. The term “salesperson” is not meant to be limiting, but merely exemplary for description purposes.

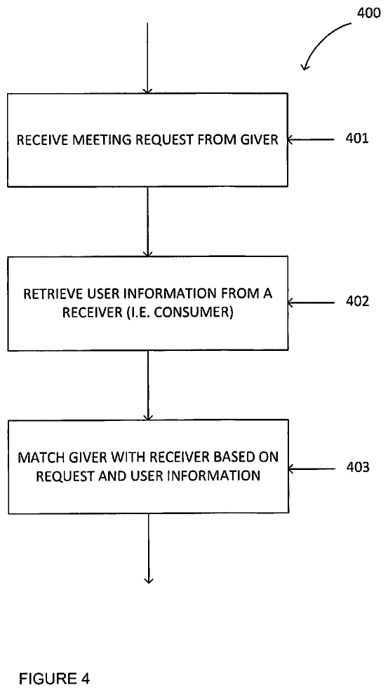

FIG. 4 illustrates an exemplary workflow 400 of the present invention and starts 401. A meeting request is received from a salesperson. The meeting request can specify certain parameters that specify who the salesperson would like to meet with to give the sales pitch. For example, the salesperson can specify anyone who is “[Single AND mother AND earns 150K+] OR [married AND 3 kids] IS inside 1 mile of offer.” Further the meeting request can specify meeting incentives that would be used to barter for the consumer's time to listen to the actual sales pitch and the expected meeting duration. In step 402, user information is received from the consumer. In step 403 the matching engine performs the matching of the Giver, or salesperson, with a consumer based on the criteria received in steps 401 and 402 and as explained above. In step 403 the meeting occurs and the process ends.

In a further example, a meeting request can be made by a salesperson with a specific consumer. The meeting request would include the salesperson's available times based on specific entry or via a calendar link. The matching engine would then access the specific consumer's available times and the meeting would be set up. A salesperson could also set up meeting requests for meetings to be held with a certain demographic during anticipated lunch hours at a frequently visited restaurant by the salesperson.

A consumer who is part of the service would receive an invitation to accept a meeting as proposed by the matching engine. The consumer would then be given the opportunity to accept, decline, or propose an alternate time. For example, a consumer may receive on their telecommunications device (i.e., smartphone, tablet, laptop, wearable device, or the like) a prompt “XYZ would like to meet with you and is 500 feet away and can meet you for lunch at Pizza Shop. He would like to pitch Sneakers and will buy you lunch while he talks about it. The meeting will last 15 minutes.” In another example, the consumer would be prompted with “XYZ would like to meet with you any time next week; he will pay for your cab home and pitch his product on the way. The average meeting time is XXX minutes and he sells enterprise storage from ZZZ company.” These are meant to be illustrative examples and do not limit the invention in any way. The consumer would then be given the chance to reply to the prompt to accept, decline, or reschedule the sales pitch meeting. A consumer could indicate that they would be willing to meet if offered a better deal (i.e. better meal). When a consumer is prompted for a meeting, they are privy to ratings and/or reviews of the requesting salesperson. For example, a consumer may learn that the salesperson has a certain rating (i.e., 4.5/5.0) and can read comments left by previous consumers. Comments can indicate “too much talking” or “sells a good product” or “incentives worthwhile.”

Compliance rules are utilized to be in conformance with applicable rules, regulations, and ethical codes of conduct. The system would be enabled to monitor meetings, incentives, and gifts provided to ensure compliance. Further, salespersons attached to a certain entity, like a certain company, and may be governed by explicit rule sets. The rule sets would comprise certain user-defined variables (e.g., allow, deny; implicit, explicit), and based on certain conditions. For exemplary purposes:
Only lunch meetings (implicit deny; explicit allow)
Any meeting EXCEPT lunch meetings (implicit allow; explicit deny) Certain conditions would apply in the following example:
NO offsite meetings unless meeting from an approved offsite location (approved lists or type list)
NO lunch/dinner meetings at restaurants that serve alcohol Example rules for Doctors:
NO meetings with Pharmaceutical Reps
NO meetings with Pharmaceutical Reps from a banned firm
If doctor is on medication formulatory board, then no meetings with Pharmaceutical Reps

These examples are meant to illustrate the invention and not meant to be limiting.

In another alternative embodiment, a referral system is created where an attorney meeting certain criteria with nothing to do can take disclosures offered up by other lawyers who need assistance and can bill appropriately.

Data keys, or hashes, are created for each person profiled in the system. A hash is used to encrypt the profile data wherein different hash keys unlock different layers of a user's profile. Therefore, a user can choose to decrypt or reveal only to a certain extent, as desired. For example, the user can reveal a salary range as opposed to an exact figure. A user can reveal that they have children, but would not have to reveal how many or their ages. Encrypted data like user characteristics can also be selectively revealed (i.e., hair color, height). Different users in the systems are given different levels of verification. A consumer that has provided third party information would be given a higher level of verification. Third party information includes proof of salary, tax returns, or the like. The verification data is then used to provide matches via the matching engine. The verification data also protects a salesperson when bartering a high-priced item. For example, a salesperson would only want to offer a sales pitch meeting on a yacht to ten people that are actually verified to have a certain income level (i.e. $1 Million+).

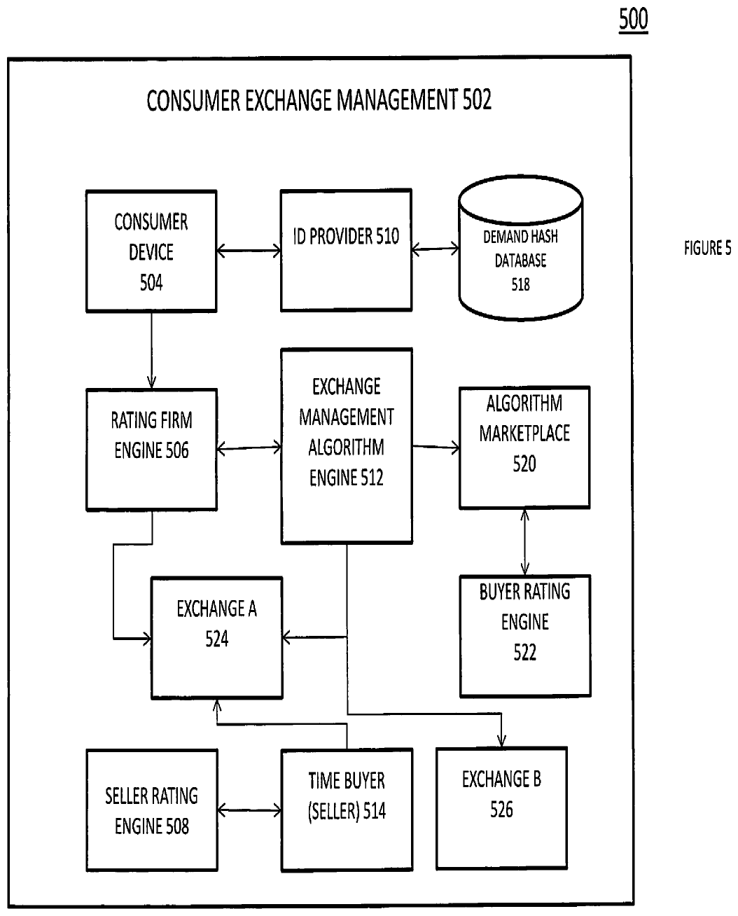

FIG. 5 is a high-level diagram 500 of another embodiment of the invention. An exemplary consumer exchange management system 502 according to at least one embodiment of the invention is shown. A consumer device 504 is communicatively coupled and matched with a time buyer (seller) 514 via an Exchange A 524. In an alternative scenario, the consumer device 504, or other consumer device (not shown) may be coupled and matched to another time buyer (seller) (not shown) via another exchange, for example Exchange B 526. Consumers can split, or route, their available time to multiple exchanges. Each exchange may further have a set of rules for types of transactions, bidding processes, and/or consumers/sellers that are permitted.

The Consumer Device 504 may access an ID provider 510 to retrieve a Demand Hash. The Demand Hash may be stored locally at the ID Provider 510 or in a remotely, for example in Database 518. Consumers may therefore control how their Demand Hash is traded on an exchange. The Demand Hash may store demographic information associated with the user of the Consumer Device 504. The demographic information may include, but is not limited to, income, race, number of children, or the like. The Demand Hash may further include consumer preferences (e.g., shoe shopping, food preferences) as well as other spending habits or past spending history. The Demand Hash may also provide values for certain time slots associated with the consumer. The values may be weighted differently based on settings predetermined by the consumer or otherwise (i.e. default settings). For example, the consumer may assigned a heavier weight (i.e. more expensive) value to a time slot from 12:00 PM-1:00 PM and a lighter weight (i.e. less expensive) value to a time slot from 10:00 AM-10:30 AM. As described above, the amount of information divulged to 3^{rd} parties and the like are in complete control by the consumer. A consumer may designate certain manufacturers' special permission to view online purchasing habits associated with a certain set of retailers.

Consumers may utilize a Rating Firm Engine 506 to analyze the information provided by the Demand Hash associated with the consumer. For example, the Demand Hash may assign a confidence factor rating to the Demand Hash by determining the truthfulness of the data in the Demand Hash. This may be determined by evaluating whether, for example, the income level provided by the consumer is accurate or whether the consumer actually prefers certain cuisine. Ratings may be assigned as described above.

A consumer may use an Exchange Management Algorithm Engine 512 in conjunction with an Algorithm Marketplace 520 to handle matching of the consumer with a seller via one of the exchanges A or B. The Algorithm Marketplace 520 may provide algorithms for consumers to select that best meet their needs. The algorithms may optimize the sales pitch experience for both the consumer and the seller as opposed to simply monetary gain. The algorithms may be stored locally (i.e. on the consumer's device) or remotely (i.e. on a cloud platform).

The Algorithm Marketplace, in one embodiment, may be accessed by the consumer via the Exchange Management Algorithm Engine 512. The Engine 512 may control how the consumer and seller are effectively matched using a selected algorithm. For selling large slots of their time, consumers may choose to manually manage the acceptance and rejection of seller's offers on an exchange. Alternatively, consumers may use one of the algorithms to efficiently manage the sale of the consumer's time for a meeting with a seller or otherwise. For example, a consumer may use an algorithm to sell five seconds of their browser time to view a pop-up ad for 0.5 cents. This allows the efficient selling of a consumer's time in very small increments (i.e. 5 seconds) or larger increments (i.e. 30 minutes). Consumers or other entities (i.e. firms) may write custom algorithms for other consumers to choose from for use on the exchanges. A Buyer Rating Engine 522 may be used by consumers of the algorithm marketplace 520 to provide ratings of sellers. Using engine 522, users may rate sellers for the quality of their incentives or the truthfulness of their presentations. For example, a seller who promises a free coffee but gives substandard coffee could be held accountable and subject to a bad review from the consumer. In another scenario, a seller may receive an unfavorable review for causing an offensive image to be displayed in the consumer's browser window or pop-up advertisement. Seller ratings may also be highly granular and track multiple factors around the transition including quality both of the sales pitch itself offered by the seller as well as the incentive. Other factors may be considered, such as the level of validations the seller has (e.g., criminal background check, references check). All of this data may be utilized by consumers when accepting bids via the exchanges.

A Time Buyer (seller) 514 may buy or bid on the Demand Hashes made available on one of the exchanges. In one embodiment, the seller 514 may utilize the consumer rating data generated by the rating firm engine 506 in deciding whether to place a bid on a consumer's demand hash. A seller 514 may have a seller rating engine 508 calculate a rating based on the seller's credentials. Seller rating engine 508 functions much in the same way as described above with respect to rating firm engine 506.

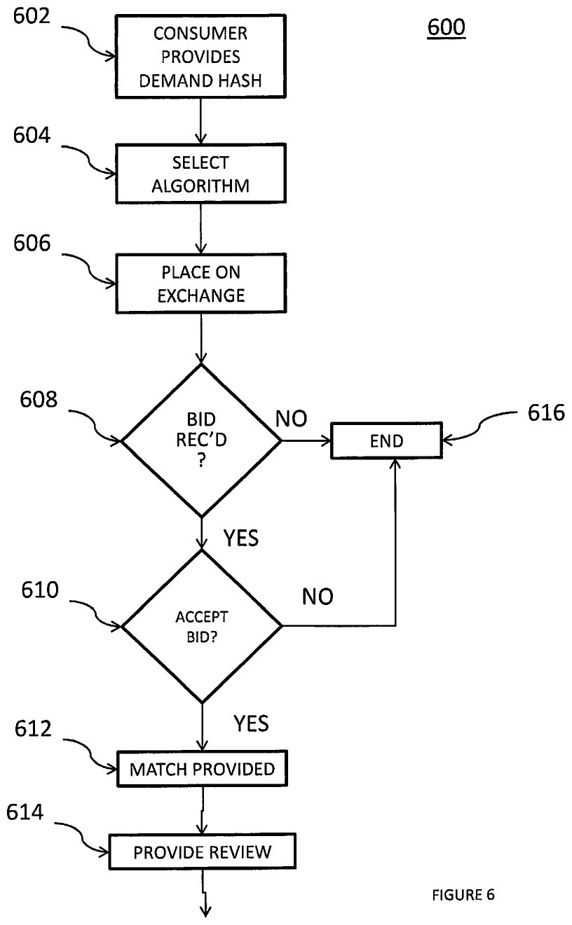

FIG. 6 is an exemplary workflow process 600 of the Exchange system. The exemplary workflow begins with step 602 where a consumer may initiate being a part of an exchange (i.e. Exchange A or B as described above) by providing his or her demand hash. In step 604, the consumer may select a specific algorithm, for example from the algorithm marketplace previously described. In step 606, the consumer's demand hash is placed on the exchange. Other information may also be placed on the exchange (i.e. the consumer's ratings) in combination with the algorithm selected by the consumer. At decision block 608, it is determined whether a time buyer (i.e. a seller seeking to make a sales pitch) has placed a bid on the consumer for the consumer's time. If No, the process ends (616). In another embodiment, the process may sit in a holding pattern (i.e. the consumer remains on the exchange until a bid is received). If Yes, the process moves to decision block 610 and the consumer may decide to accept/reject the received bid. If No, the process ends (616). In another embodiment, the process may place the consumer back on the exchange. If Yes that the bid has been accepted, the process moves to step 612 and the consumer is matched with the time buyer for a meeting as described previously in conjunction with FIGS. 3 and 5. After the meeting is held, the process moves to step 614 and both the consumer and the time buyer are provided with the opportunity to provide a review for each other which may be used by other consumers and time buyers. The process then ends.

In light of the nature of the invention, which may require real-time scheduling, updating, etc., to enable the capture of the optimized sales opportunity, signaling with respect to geography, connectivity, and the like, may be of seminal importance. Thus, another embodiment of the invention provides a method for the error correction of a digital over-the-air (OTA) signal. Using an antenna to capture OTA signals, the signals may not always be complete. The captured signal data is stored in a memory, which may be a buffer or a cache memory. To supplement the incomplete signals, further data signals may be gathered from at least one other source. This one other source may be an IP-based source, like an IP-based digital antenna. The IP-based source may be considered to be in close proximity to the broadcast source. Once both sets of data are acquired via the digital antenna and via the IP-based source, the sets of data are combined to complete a clear digital picture.

In an exemplary implementation, a digital OTA antenna may gather and store in the buffer memory 80% of the program data. In order to provide clarity of data, such as a clear picture in a television OTA signal context, 20% more of the program data may be required. Using the IP-based digital antenna, the rest of the data, such as the “app” or television program data may be acquired, combined with the 80% stored in the buffer memory and then presented or delivered for display. This example is considered to be for exemplary purposes only and is not intended to limit the invention.

In other exemplary embodiments, a broadcast program or broadcast data representing a program may be locally recorded and/or stored, like on a DVR or a TIVO device, or the like. If the broadcast program or broadcast data representing a program is determined to be imperfect or missing key data, the missing data may be ascertained from outside or external sources via IP-based sources, like an IP-based antenna.

This disclosure is to be considered as exemplary and not restrictive in character, and all changes and modifications that come within the spirit of the disclosure are desired to be protected.

1. An exchange system comprising a memory communicatively coupled to a hardware processor, the memory comprising instructions that when executed by the hardware processor cause the system to:
receive a unique demand hash for each of a plurality of consumers, each of the demand hashes comprising at least an encryption of third-party verified user data, including remote spending data and time availability for the respective consumer, and a permitted data layer for each of a plurality of different prospective time buyers, and wherein each of the demand hashes is, in part, a verification of the third-party verified user data of the respective consumer by the third-party verification source;
receive a bid from a one of the prospective time buyers directed to at least two of the plurality of consumers;
algorithmically analyze each of the demand hashes to which the bid is directed and the bid to assess a permitted data layer, if any, to the demand hash for the bidding one of prospective time buyers with respect to each of the consumers; and
establish a match between at least one of the consumers and the bidding time buyer based on the algorithmic analysis.

2. The system of claim 1, wherein the demand hash comprises demographic information of the consumer.

3. The system of claim 1, wherein the demand hash comprises consumer preferences of the consumer.

4. The system of claim 1, wherein the instructions when executed by the processor further cause the system to:
provide a confidence rating of the demand hash based on accuracy of data provided by the consumer in the demand hash according to the third-party verification.

5. The system of claim 4, wherein the rating is provided by the third party verification source.

6. The system of claim 1, wherein the consumer is notified of the established match.

7. The system of claim 1, wherein a meeting between the consumer and the time buyer is canceled in response to receiving a rejection of the bid from the consumer.

8. The system of claim 1, wherein a meeting between the consumer and the time buyer is established in response to receiving an acceptance of the bid from the consumer.
